(19) United States
(12) Patent Application Publication
(10) Pub. No.: US 2022/0063242 A1
(43) Pub. Date: Mar. 3, 2022

(54) AUTOMOTIVE GLAZING WITH A CORRECTING STRUCTURE

(71) Applicant: Central Glass Company, Limited, Yamaguchi (JP)

(72) Inventors: Markus Walter Pohlen, Mückeln (DE); Katharina Boguslawski, Trier (DE)

(73) Assignee: Central Glass Company, Limited, Yamaguchi (JP)

(21) Appl. No.: 17/299,083

(22) PCT Filed: Dec. 4, 2019
(86) PCT No.: PCT/EP2019/083746

§ 371 Date: Jun. 2, 2021

Related U.S. Application Data
(60) Provisional application No. 62/775,503, filed on Dec. 5, 2018.

(51) Int. Cl. B32B 7/023; G02B 27/00; B32B 17/10

(52) U.S. Cl. CPC B32B 7/023; G02B 27/0025; B32B 17/10036; B32B 2551/00; B32B 17/1044; B32B 17/10568; B32B 2307/418; B32B 17/10348

(57) ABSTRACT

A laminated automotive glazing (10) designed to utilize such as, e.g., a camera (18) or sensor, includes a first glass substrate (22) facing a vehicle exterior having a first side S1 and a second side S2, a second glass substrate (24) facing a vehicle interior having a third side S3 and a fourth side S4, the fourth side S4 facing the vehicle interior, and an interlayer (26) laminated between the first and second glass substrates. A correcting structure (32) is molded on at least a portion of the fourth side S4 of the second glass substrate (24) for improving optical properties of light transmitting through the first and second glass substrates (22, 24) and the interlayer (26).

### CROSS REFERENCES TO RELATED APPLICATIONS

This application claims benefit under 35 U.S.C. § 1.119(b) in U.S., or similar statutes in other countries, of U.S. provisional patent application Ser. No. 62/775,503, filed Dec. 5, 2019, entitled “GLAZING HAVING A MOLDED STRUCTURE”, the entire contents of which are incorporated herein in their entirety.

### TECHNICAL FIELD

The present disclosure generally relates to an automotive glazing having a correcting structure molded thereto to correct optical distortion in the glazing, and to methods of forming such a correcting structure.

### BACKGROUND ART

Information acquisition systems are used in vehicles for improving safety performance or comfort during use of the vehicle. This type of system may include imaging systems, anti-collision systems, brake assisting systems, driving assistance systems, and autonomous driving systems using various electric sensors or cameras.

Electric sensors or cameras used in information acquisition systems are typically mounted directly on an inner surface of a laminated vehicle windshield or positioned near a vehicle windshield. The sensors or cameras collect information on conditions outside a vehicle by emitting and/or detecting infrared rays, near-infrared rays, laser radar and/or visible light through a windshield.

In order to hide the electric sensors or cameras from view from outside a vehicle, an opaque layer (e.g., dark colored ceramic printing and/or silver printing) may be printed on an inner surface S2 of an outer glass (first glass) or on an outer surface of an inner glass (second glass), in addition to an opaque printing region in the periphery of the laminated vehicle windshield. Such opaque printing regions for hiding may have an opening (i.e., a local area without opaque printing), a so-called “camera opening” or viewing area, so that the information acquisition system may collect information from outside the vehicle through the camera opening.

Autonomous driving technology makes extensive use of optical sensors (camera systems) and relies on good image quality. Imperfections in the surfaces of the windshield or other vehicle windows induce optical distortions and should be reduced or minimized in order to reach optimal image quality.

It is therefore an object of the present disclosure to provide an automotive glazing minimizing optical distortions which can affect use of various sensors and camera systems in vehicles.

### BRIEF SUMMARY OF EXEMPLARY EMBODIMENTS

The present disclosure relates generally to a laminated automotive glazing comprising: a first glass substrate, towards a vehicle exterior in use, having a first side and a second side; a second glass substrate towards a vehicle interior in use, having a third side and a fourth side, the fourth side facing the vehicle interior; an interlayer laminated between the first and second glass substrates; and a correcting structure molded on a portion of the fourth side of the second glass substrate. The correcting structure is to improve the optical properties of light transmitted through the first and second glass substrates and the interlayer at the region of the correcting structure. As described below, the correcting structure can be a formed or molded layer of translucent resin, formed onto the surface of the glass substrate, preferably an inward or interior surface. It may be a local structure formed to occupy the region of a camera opening or viewing area of the glazing, which may be a region surrounded by or defined by an opaque region. It may have a form adapted to compensate optically for a non-uniformity of a glass substrate at that region, e.g. at the same surface, or at an opposing surface. The glazing may be a curved/bent glazing such as a windshield.

In further embodiments, the correcting structure may be formed in a portion of the glazing such that a light receiving device is placed adjacent to the correcting structure. The glazing according to the invention may have an optical power which, presented as absolute value, is 150 mdpt or less, preferably 100 mdpt or less, and more preferably 75 mdpt or less. The correcting structure may be placed near an opaque area and may partially overlap with the opaque area.

In further embodiments, the correcting structure may function to reduce distortion of light to be received with the light receiving device. In some embodiments, the correcting structure may be formed to match light paths from the first side (outward side) of the first glass substrate so as to avoid generating double images, or so as to improve (e.g. reduce and/or make more uniform over the structure region) beam deviations through at least part of the glazing. The correcting structure may be made from a translucent resin. It may be any of an ultraviolet-curable material and a heat curable material. Further, the correcting structure may be covered with a coating film, such as, e.g., a protective coating or an anti-fog film.

The present disclosure further relates generally to a method of producing an automotive glazing having a correcting structure for improving optical properties of light transmitting through the automotive glazing, comprising the steps of: preparing the automotive glazing; applying an uncured resin to the prepared automotive glazing; molding the uncured resin to form a desired surface of the correcting structure; and curing the uncured resin to form the correcting structure. During the molding step, the uncured resin may be molded using a mold, and wherein the mold can be aligned by monitoring reflective light traveling from a mold surface and from a glazing surface. The glazing produced may have any of the features disclosed herein for the glazing.

In embodiments, the resin may be ultraviolet light or heat curable. Where the resin is ultraviolet light curable, the ultraviolet light illumination may be administered through at least one of the glazing or the mold and may be applied using the glazing as a waveguide. Embodiments may include treatment of the glass substrate surface to affect adhesion of the surface prior to application of the resin thereon.

The present disclosure yet further relates generally to an automotive glazing comprising: a glass substrate having a first side and a second side, the second side facing a vehicle interior; and a correcting structure molded on a portion of the second side of the glass substrate for improving optical properties of light transmitted through the glass substrate. In this aspect, any compatible features disclosed herein for the first glazing aspect are applicable.

### BRIEF DESCRIPTIONS OF THE DRAWINGS

The accompanying drawings, which are incorporated into and constitute a part of this specification, illustrate one or more example aspects of the present disclosure and, together with the detailed description, serve to explain their principles and implementations.

FIG. 1 shows a schematic view of an automotive glazing having a light receiving device opening region according to an exemplary embodiment of the present disclosure;

FIG. 2 illustrates a cross-section of an automotive glazing according to an exemplary embodiment of the present disclosure along line A-A′ in FIG. 1;

FIG. 3 illustrates a cross-section of an automotive glazing according to an exemplary embodiment of the present disclosure along line C-C′ in FIG. 1;

FIG. 4 illustrates a cross-section of an automotive glazing according to an exemplary embodiment of the present disclosure;

FIG. 5 illustrates a cross-section of an automotive glazing according to an exemplary embodiment of the present disclosure;

FIG. 6 shows a method for producing an automotive glazing having a correcting structure according to an exemplary embodiment of the present disclosure;

FIG. 7 illustrates a process cross-sectional view of a step for preparing an automotive glazing according to an embodiment of the present disclosure;

FIG. 8 illustrates a process cross-sectional view of a step for applying an UV-curable resin according to an embodiment of the present disclosure;

FIG. 9 illustrates a process cross-sectional view of a step for placing a mold on the resin according to an embodiment of the present disclosure;

FIG. 10 illustrates a process cross-sectional view of a step for aligning the mold according to an embodiment of the present disclosure;

FIG. 11 illustrates a process cross-sectional view of a step for radiating ultraviolet ray according to an embodiment of the present disclosure; and

FIG. 12 illustrates a process cross-sectional view of a step for releasing the mold to form a correcting structure on the automotive glazing according to an embodiment of the present disclosure.

### DESCRIPTION OF EMBODIMENTS

High-resolution information acquisition systems, or light receiving devices, for automated safety operations or automated driving of a vehicle may require a glazing with minimal optical distortion in a large camera opening such that information may be correctly processed by such systems. The information acquisition systems may require distortion levels that are limited by the capabilities of a glazing. Thus, it is desired to improve optical quality in a glazing.

For purposes of this disclosure, including with reference to the figures, a surface “S1” may refer to an exterior glass substrate surface in a glazing. A surface “S4” may refer to the interior glass substrate surface of a laminated automotive glazing. A surface “S2” may be a glass substrate surface opposite Si and a surface “S3” may be a glass substrate surface opposite S4. In a laminated glazing, S2 and S3 may face each other within the laminated glazing. In a single pane glazing, S2 may be the interior surface of the glazing.

Cameras and sensors, collectively referred to as light receiving devices, are increasingly used in vehicles and may be preferably placed within a vehicle to provide better protection and environmental conditions for the electronic light receiving devices. Where a light receiving device is placed inside the vehicle, it may collect data through a surface, typically a glass window. The glass window may preferably have minimal distortion to provide a clear viewing surface for the camera or sensor. As technology develops, more powerful cameras and sensors are available that may be increasingly sensitive to the optical properties of the glass window. Optical properties may be affected by beam deviation, distortion, or double images caused by the shape of a glass window. Deformations in the glass of a glass window may affect such optical properties. This may be of particular concern where the camera or sensor is placed behind a laminated glass construction, such as a windshield.

Beam deviations may be measured to determine a lens effect in a glazing. For example, a set of points may be projected and measured by a camera and then measured again with the camera but with a glazing between the projection and the camera. The difference in location of the points may be used to determine how light is passing through the glazing to a camera. The beam deviation may be used by a camera system to understand the information collected by a camera, such as the path of a moving object or whether an object is stationary. The beam deviation may be measured by measuring the distance between where a point of light is measured without the glazing to the point measurement of light which passed through the glazing, at two points in a glazing, and providing a ratio of such distances. A homogeneous glazing surface may provide a ratio close to one where, even though the point may change in location, the changes are more uniform. Improved optical properties may include a beam deviation ratio close to one, or 100%. Preferably, the beam deviation ratio in or over the area of the correcting structure is from 0.95 to 1.05, more preferably from 0.98 to 1.02, and even more preferably from 0.99 to 1.01. In some embodiments, a different beam deviation ratio may be targeted based on the location of the beams of light and the correcting structure design. The distance between the first projected point and the second projected point may vary based on the size of a correcting structure. The optical power may be described as the spatial change of the beam deviation as described in equation I:

optical power=d alpha/dx.

In the equation I, d alpha relates to the change in beam deviation between two parallel beams at distance dx from each other as described in ECE-R43 (Regulation No 43 of the Economic Commission for Europe of the United Nations (UN/ECE)—Uniform provisions concerning the approval of safety glazing materials and their installation on vehicles).

Optical distortion may occur in laminated glass constructs. The distortion in a laminated vehicle glazing may create distortion by a convex lens effect with positive optical power and a concave lens effect with negative optical power. Optical power (in diopters, “dpt”) is defined as the inverse of the focal length of the convex/concave lens, typically presented in millidiopter (“mdpt”). Optical power may be positive or negative mdpt depending on the lens shape. In conventional laminated glazings, optical power, presented as absolute values, may be in the range of approximately at least 200 to over 300 mdpt in a camera opening region. As disclosed below, the glazing according to some embodiments of the present disclosure includes a correcting structure for improving optical properties of light transmitted through the first and second glass substrates and the interlayer. Improved optical properties may particularly include optimizing beam deviation, decreasing distortion, and decreasing double images. The correcting structure may improve the optical power of the glazing in some particular embodiments which may decrease distortion of light transmitted through the glazing. The optical power of at least part of a glazing, according to some embodiments, may be, presented as absolute values, preferably less than 150 mdpt, more preferably less than 100 mdpt, and further preferably less than 75 mdpt. Levels of optical distortion and double imaging (secondary images) may be measured as defined in ECE-R43 (Regulation No 43 of the Economic Commission for Europe of the United Nations (UN/ECE) Uniform provisions concerning the approval of safety glazing materials and their installation on vehicles).

Among other features, the present disclosure provides an improved performance camera or sensor viewing area in a glazing. The glazing may be a single glass pane or a laminated glazing. The glazing surface adjacent to a camera or sensor (S2 in the single glass pane or S4 in the laminated glazing) may include a correcting structure molded thereto. The correcting structure may provide any suitable surface shape, including a nominal surface, a complement to an outward surface e.g. Si, or a wedge shape to improve optical properties.

Glass may have optical power variations in a horizontal direction which affect transmitted distortion in the glass and may be formed by draw lines formed during glass production which may extend vertically in a laminated glazing. Draw lines may include refractive index inhomogeneities, thickness variations, or combinations thereof in a glass substrate. When the glass substrates are manufactured by the float process, outward surface S1 of the first glass may be the bottom surface of the glass and the direction of the draw lines may be parallel to the z-direction (vertical/upright in an installed window). Depending on production and process parameters, the glass surface may have different surface waviness or curvature. Depending on the process and use, the uneven glass surface may be at any of surfaces S1, S2, S3, and/or S4 in a glazing. When the direction of the draw line is perpendicular to the z-direction, the optical distortion may also become worse due to the glass bending process, which may enlarge existing distortion. Where multiple glass substrates are combined, such as in a laminated glazing, the refractive power and distortion may increase as one substrate may act as a lens, amplifying the distortion of another glass substrate. The transmitted distortion due to waviness or curvature from production may affect the functionality of a camera or sensor receiving information through the glass.

Further, glass substrates may include distortions formed due to an opaque printing (opaque printed layer) on the glass substrates. For example, flat glass sheets may be bent at thermal bending process temperatures (e.g., greater than 580° C. for soda-lime glass which may be defined ISO 16293-1:2008) to form a two or three-dimensional shape to fit a vehicle's window. Opaque printings may be printed by, for example, screen-printing on flat glass sheets before thermal bending. The screen-printed opaque printings are then fired in the temperature range of 580-700° C. during the thermal bending process to form a rigid print with high mechanical durability. In such manufacturing processes, differences in physical properties such as light absorptance, elastic modulus or coefficient of thermal expansion may be shown between the opaque printing materials such as black-color ceramic paste and the glass sheet such as transparent or semi-transparent soda-lime-silica glass material. For example, a black-colored ceramic printing typically may absorb relatively more heat in a bending furnace than the glass sheet, resulting in inhomogeneous temperature distribution in the glass sheet. Temperatures in areas of the glass sheet near the black-colored printing area may be locally higher than those areas away from the printing. Moreover, differences may exist between the coefficients of thermal expansion (CTE) of the black-colored ceramic printing and the soda-lime-silica glass sheet, resulting in residual stress after the temperatures are cooling down. For at least these reasons, the optical distortion near the opaque printing may be created after the thermal bending process.

The relationship between optical power and local surface curvatures may be, in a simplified way, given by the equation II:

$$Optical power = \frac{1}{f} = ( n - 1 ) [ \frac{1}{{r}_{1}} - \frac{1}{{r}_{2}} + \frac{( n - 1 ) t}{n {r}_{1} {r}_{2}} ]$$

wherein f is focal length, n is refractive index, r₁ is the radius of local curvature of the first glass substrate, r₂ is the radius of curvature of the second glass substrate, and t is thickness of the local lens. According to equation II, it is understood that the optical power is a function of local surface curvature r₁ in the first glass substrate and r₂ in the second glass substrate, or local surface curvatures in the S1 and S4 surfaces after lamination. Optical power may vary within the camera opening.

Further, glass distortions may be created in localized areas of heating. For example, heating mechanisms, including heatable silver lines, may be present in a camera or sensor viewing field. The heating mechanism may be necessary to keep the area clear of frost and/or fog. Silver may be screen printed, commonly as a pattern of lines, onto a glass substrate and later provided with an electrical connection to provide heat and clear the camera or sensor viewing field. The silver print may be at one surface S2, S3, and/or S4, preferably S4 or interior surface. Due to higher heat dissipation of the silver compared to glass without silver, a thermal inhomogeneity may occur during the glass bending process. The local change in temperature may cause profile deviations around the printed silver lines, which are not desirable and may create distortion in the camera or sensor viewing area. As the silver may be printed on only one glass sheet, a laminated glazing may have different glass deviations which may increase the optical power of the glazing. The distortion may be corrected by embodiments of the present disclosure.

To address the glass surface distortion and inhomogeneities, a correcting structure may be formed to optimize the viewing field. In some embodiments, a correcting structure may provide a homogeneous area in a glazing for a camera or sensor to collect information. The homogeneous surface may provide a suitable surface through which a camera or sensor may collect information from a distance. The correcting structure may provide a flat surface in front of a camera or sensor, or provide a matching surface corresponding to a distortion, e.g. with an inward non-flat surface form corresponding to a distortion in an exterior glass surface. For example, surface S2 or S4, in a single pane glazing or laminated glazing respectively, may include a correcting structure formed to match the light paths through surface S1. Light transmitted through surface S1 may then not substantially change paths when transmitting through the correcting structure on surface S2 or S4. Where the correcting structure creates a homogeneous area, light transmitting through may deviate similar amounts at different points.

Disclosed embodiments include laminated glass and single glass panes having a correcting structure to address at least one area of distortion in the glass. The glass substrate(s) may be any suitable glass, including soda-lime-silica glass, which may be defined by ISO 16293-1:2008. Clear, green, tinted, or privacy-color glass from 0.40 to 3.0 mm thick may be preferably used. The substrate(s) may be initially flat and heat treated to be bent to a desired curved shape for a particular window application. Typically, such bending may include heating the substrates to a temperature from 560° C. to 700° C., preferably from 580° C. to 650° C.

In certain laminated embodiments, a polymer interlayer may be sandwiched between at least two glass substrates in a laminated glazing. The polymer interlayer may be any suitable material, including polyvinyl butyral (PVB), ethylene vinyl acetate (EVA), or an ionomer interlayer. The polymer interlayer may further be an acoustic insulating layer and/or a wedged angle interlayer used for head-up displays. The polymer interlayer may further include printed or colored material in at least a portion of the interlayer. A glazing having a colored or printed polymer interlayer may or may not include opaque printing on the glass substrates. During a lamination process, which may include autoclaving, the glass substrates with the polymer interlayer therebetween are heated to at least one laminating temperature and pressure (for example, 110 to 160° C. and 10 to 15 bar) to laminate the glass substrates and form a vehicle window product. Additional interlayers and coatings may be included, such as infrared reflecting coatings or a heatable polymer interlayer with embedded heating wires.

The correcting structure may have any desired shape. For example, the mold may provide a flat surface or an S1 (outward surface)-matching surface. Where a deformation is on an interior glass surface (S2 or S4), the deformation may be filled with a material to form a correcting structure which may provide a flat, nominal surface to correct the deformation or non-uniformity in S2 or S4. Light may then transmit through the nominal surface without causing changes in light direction. In some embodiments, S1 may have a deformation. A mold may be used to form a correcting structure having the shape of the Si deformation. The correcting structure shape corresponding to the deformation allows the light to transmit through S2 or S4 without changing direction. Where there are distinct deformations in Si and S2 or S4, a mold may be used to form the correcting structure to match the S2 or S4 surface to the Si surface, such that a light path is consistent through the glass surfaces. The deformation in S2 or S4 may be filled and a surface of the filling material may be shaped by the mold. It will be understood that a nominal surface is a surface matching the model or ideal surface contour of the glazing at the region concerned, without deformation, which may be flat or curved.

The correcting structure may further be molded to a wedge shape. Light from sources outside the vehicle may be transmitted through S1 and S4 to the camera or sensor. However, S4 may create a certain amount of reflected light which is again reflected by S1 towards the camera or sensor. A wedge-shaped windshield may prevent a double image by aligning the two transmitted rays such that a single or substantially single image is received by the camera or sensor. In certain embodiments, the correcting structure may be shaped as a wedge. In some embodiments, the wedge may be larger at a bottom edge and decrease in thickness towards a top edge to adjust for light directed into the glazing from an exterior.

The correcting structure may further be a shape to correct for a wedge-shaped interlayer or other interlayer variations. A non-uniform interlayer may affect the relationship between the S1 and S4 surfaces. For example, an angled interlayer (wedge-shaped) is meant to alter reflective light paths in a particular direction. An interlayer may further be non-uniform due to the interlayer manufacturing or glazing lamination processes. The correcting structure may be formed to align the S1 and S4 surfaces to account for the non-uniform interlayer shape. The thickness of the correcting structure may vary depending on the non-uniform structure of the interlayer.

The thickness may depend on the shape of the glass surface the correcting structure is formed on. The correcting structure may be various sizes and shapes depending on the camera, sensor, and glass requirements. Due to increasing requirements of improved sensors and cameras, the area of the camera or sensor opening may be greater than 80 cm², preferably greater than 100 cm², and more preferably greater than 120 cm². The overall change of optical power across a viewing area is important to the information provided therethrough. The overall of change may increase with an increase in the camera area size as there is a larger local surface curvature change, which may decrease the optical quality of the area.

The correcting structure may cover part or all of a camera or sensor viewing area. Further, the edges of the correcting structure may overlap with opaque printing on the glazing such that, where the opaque printing is positioned between the correcting structure and the vehicle exterior, the edges of the correcting structure may not be visible from a vehicle exterior.

The correcting structure may be formed on the glass surface using a mold to shape a filling material. The filling material may include a resin, which may be ultraviolet (UV), heat or chemically curable. The resin may have a low shrinkage; however, the mold may be formed to accommodate any shrinkage that does result from the curing process such that the desired structure shape and size may be provided after any shrinkage. The resin material may desirably have a refractive index preferably equal to that of the glass substrate it is formed on. For instance, without limitation, soda-lime glass substrate may have approximately a 1.52 refractive index measured by V-block method at d line at a wavelength of 587.6 nm (based on JIS B 7071-2: 2018, “Measuring method for refractive index of optical glass—Part 2, V-block refractometers method). Where the refractive index of the resin matches that of the glass substrate, light transmitted there through may not be reflected at the resin-glass surface. Since refractive index generally depends on wavelength or frequency of light, the refractive index of the resin may match that of the glass substrate at least at a range of wavelengths or at a particular wavelength which may be used in cameras or sensors. Light may freely transmit through the glazing and the resin correcting structure where the refractive index of the resin and the glazing match. Where the refractive indices of the resin and the glass substrate do not match each other, it is still permissive to employ the correcting structure having a refractive index within a certain value, such as, e.g., plus or minus 0.05 difference from a refractive index of the second glass substrate. The resin may include, as a non-limiting example, Norland Optical Adhesive 61 from Norland Products Incorporated having the refractive index of 1.56 at the visible light wavelength of 587.6 nm. The resin may be applied to a glass surface in an uncured state having a viscosity such that the resin may form to the glass surface.

Resins for forming the correcting structure may include adhesives for photo-coupling purpose or optical fiber connection. Such adhesives may be exemplified from resins having a base resin of epoxy resins and acrylic resins having fluorine atoms with a relatively lower refractive index, and epoxy resins having bromine atoms and vinyl resins with sulfur atoms with a relatively higher refractive index. The refractive index of the resin is adjustable, and can be chosen with respect to the automotive glazing. The correcting structure made of such a resin may have a higher refractive index than that of the second glass substrate.

The resin may be cured by any suitable means. For example, in certain UV-cured embodiments, the resin may be cured by UV-illumination through the shaping mold. The mold may be transparent to UV light in a wavelength used to cure the resin. The resin may also be cured through UV light administered through the glass substrate or laminated glass product. In a laminated glass product, the resin may be selected such that the resin is cured with exposure to wavelengths above 380 nm. A polymer interlayer may be UV-absorbing and to cure the resin through the interlayer, a light wavelength not absorbed by the interlayer may be used to cure the resin. In further embodiments, a prism may be used to direct a UV light source and using the glass substrate(s) as a waveguide with total internal reflection in the glass substrate(s) to direct the light to the resin within a mold. The light introduced to glass substrate(s) with total internal reflection may be introduced from a major or non-major side of the glass substrate(s). A non-major side of the glass substrate(s) may include an edge of the glass substrate(s).

The mold may be any suitable material and may not adhere to a filling resin, such that the mold may be removed from the cured resin without damaging the surface adjacent to a camera or sensor. The mold may be a non-adhering material or be coated with a non-adhering material, such as nickel or a release agent. The release agent may include, as a non-limiting example, perfluoropolyether silane based product such as FluoroSyl 4500 of Cytonics LLC. Further, the mold may be any suitable two or three-dimensional shape to form a correcting structure as described herein.

In some further embodiments, a hard coating may be formed over the cured resin. Such a hard coating may provide a protective layer over the resin. In some embodiments, an anti-fog film may be provided over the resin to provide an anti-fog surface in the face of a camera or sensor. Such a resin also may be provided with a transparent film, which can be removed before the completion of the production or can be built together with the correcting structure.

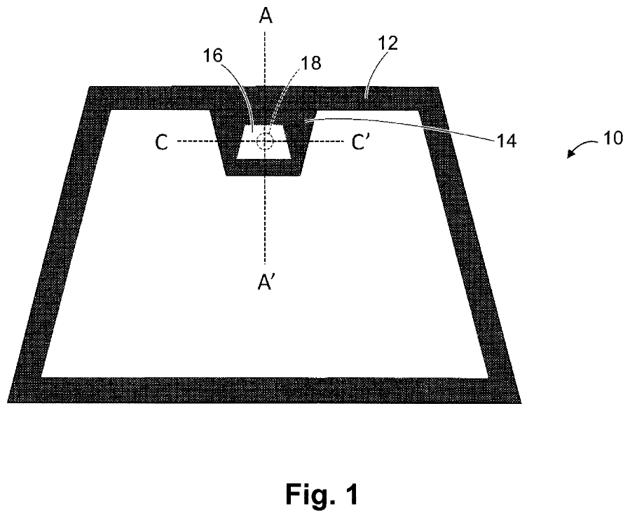

Referring to FIG. 1, an automotive laminated glazing 10, a windshield, according to a first embodiment, is shown having opaque printing 12, 14. An opening 16 in the printing 14 is shown where a camera 18 may be provided behind the glazing 10. The opening 16 provides a camera opening or viewing area through which a camera 18 or other sensor may collect information. For the purpose of illustration, the laminated windshield 10 may be also called as the laminated glazing 10, interchangeably.

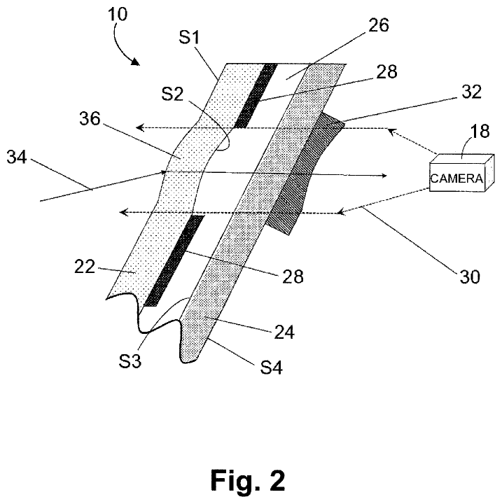

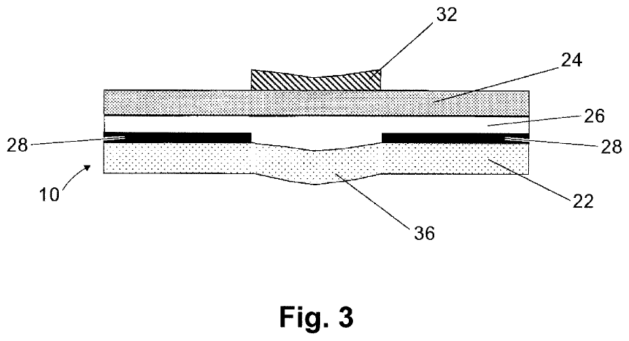

FIG. 2 shows a cross section of the laminated glazing 10 across the A-A′ axis as shown in FIG. 1 at a camera viewing area 16 having a deformation on surface S1 of a first glass substrate, which may be an outer glass substrate 22. The outer glass substrate 22 is laminated to a second glass substrate, or an inner glass substrate, 24 with a polymer interlayer 26. An opaque printing 28 is on surface S2 of the outer glass substrate 22 outlining or surrounding a viewing area 30 of camera 18. Deformation 36 may be formed during a bending process of the glass substrate 22 wherein the printed area 28 may have caused increased heating around the opening 16 compared to glass further removed from the printing 28, causing a deformation 36 in the glass substrate 22. A correcting structure 32 is molded on surface S4 of the inner glass substrate 24 and has the same surface shape as the deformed surface S1—but in reverse—such that light 34 transmitting through the glazing 10 is not distorted by differences between surface S1 and surface S4. FIG. 3 shows the laminated glazing 10 across the C-C′ axis as shown in FIG. 1. The correcting structure 32 is molded onto the inner glass substrate 24 to complement the outer glass substrate 22 surface deformation 36 over the a camera viewing area. The polymer interlayer 26 may be printed or colored in some embodiments.

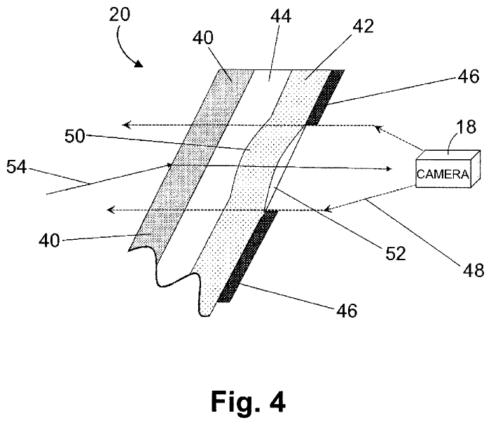

FIG. 4 illustrates a laminated glazing 20 having a deformation on surface S4 of an inner glass substrate 42, surrounded by opaque printing area 46 around a camera 18 with a viewing area 48. The inner glass substrate 42 is laminated to an outer glass substrate 40 with interlayer 44 therebetween. Deformation 50 in the inner glass substrate 42 is filled with a correcting structure 52 complementary in form, to provide an inward surface matching the surface S1 on the outer glass substrate 40. Light ray 54 reaching the camera 18 is not distorted by a change in glass curvature between the surfaces S1 and S4, providing an improved optical power. In some embodiments, the correcting structure 52 may have a flat or nominal surface which may or may not match an opposite surface of the glazing 20. The correcting structure 52 may be of a resin material that has a surface formed by a mold, not shown. The mold may include a non-adhesive coating, such as nickel that will not adhere to the resin.

The correcting structures 32, 52 may be formed by placing a resin onto the camera viewing area of surface S4 of the inner glass substrate 24, 42 after lamination of the glazing 10. The resin may then be molded to have an inward surface matching surface S1 of the outer glass substrate 22, 40 in form. The resin is then cured and the mold, having a non-adherable surface may be removed from the resin. In other embodiments, the resin may be formed on a glass substrate 24, 42 prior to lamination. The lamination process may preferably include de-airing and autoclaving the laminate in a pressurized bag where the correcting structure is formed prior to lamination.

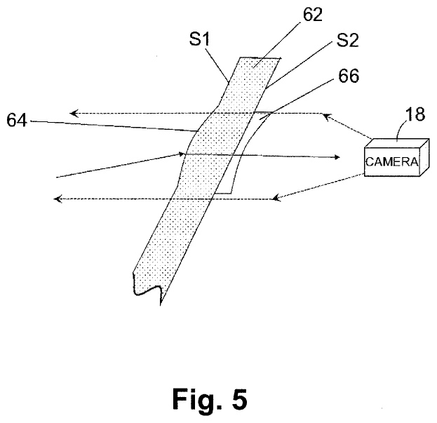

Regarding FIG. 5, a single glass pane 62 may have a deformation 64 on a single surface, such that surfaces S1 and S2 have distinct surface geographies or contours. The correcting structure 66 may be formed on inward surface S2 such that a correcting structure surface matches the deformation 64 of outward surface S1 to provide a consistent light path to a camera 18 or sensor. In certain embodiments the deformation 64 may be on inward surface S2. As shown on surface S4 in FIG. 4 in the laminated glazing 20, surface S2 of a single glass pane 62 may similarly include a deformation that is filled in by a correcting structure to provide a smooth surface or structured surface to complement surface S1.

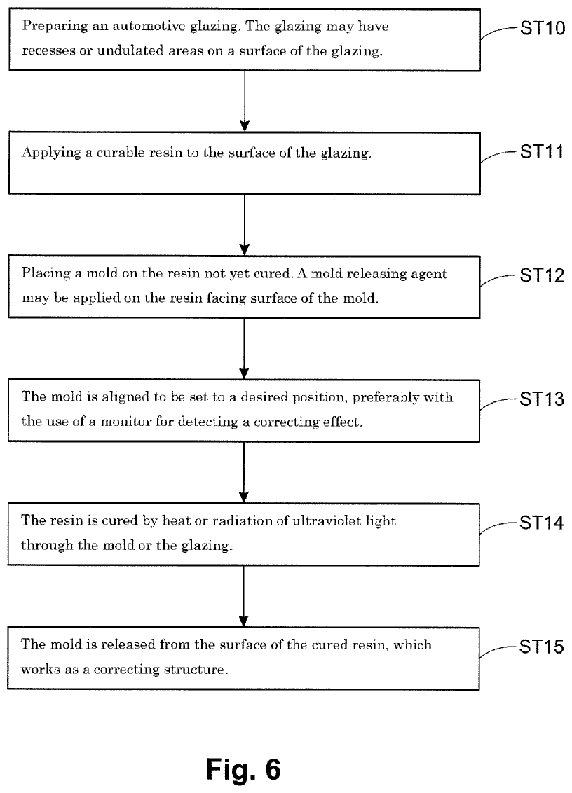

Automotive laminated glazings according to the present disclosure may be manufactured according to a method shown in FIG. 6. First, an automotive laminated glazing may be prepared (at step ST10). The glazing may include a first glass substrate, a second glass substrate, and an interlayer positioned between the first and second glass substrates. Opaque areas may be formed at the edges of the glass substrates including areas near or surrounding/defining an opening for a light receiving device to receive light through the glazing. The opaque areas may be generally formed by, e.g., a screen-printing method on flat glass sheets before thermal bending. The screen-printed opaque printings may then be heated to a temperature in the range of 580—700° C. during the thermal bending process to form a rigid print with high mechanical durability. When a black-colored ceramic printing is used, such a printing typically may absorb more heat in a bending furnace than the glass sheet which may result in inhomogeneous temperature distribution in the glass substrate, thereby causing deformations or deviations near the opaque area on the surface of the glass substrate. The glass may include further deformations due to the glass production process.

As disclosed above, a correcting structure may be any shape for improving optical properties of the glazing. For example, the correcting structure may have a shape which fills a recessed area on a glazing surface by application of a curable resin on the glass surface. If the light receiving device opening area includes a recess on the glass surface, a curable resin may be applied to fill the recess on the glass surface (at step ST11). The curable resin may preferably be heat-curable or ultraviolet ray curable. To improve adhesion of the correcting structure, a surface of the glass substrate may be subject to a treatment improving adhesion of the correcting structure prior to application of the resin. The treatment may include application of primers and adhesion promoters and/or surface activations such as, e.g., plasma treatment or corona discharge treatment. Such surface activations may provide an improved surface for adhesion of the resin by cleaning activating or depositing layers on the glass surface.

After the application of the uncured resin, a mold may be positioned against the surface of the applied uncured resin. For the purpose of forming an optical flat surface on the correcting structure, a mold having an optical flat surface may be used for the molding step. The mold may have any desired shape, including an optically flat surface or a shape which may complement the shape of a surface opposite the correcting structure. To prevent the mold from adhering to the surface of the correcting structure, a mold releasing agent is applied on the surface of the mold (at step ST12). In some embodiments, the mold may be formed of a non-adhering material, such as nickel, or coated with a release agent.

After the mold is positioned over the uncured resin, a position of the mold can be aligned and adjusted such that the position of the correcting structure matches a desired position (at step ST13). Particularly, the tilt of a mold may be adjusted such that a desired correcting structure may be formed and no transmission double image appears. To adjust the position of the mold, an optical monitor may be used to detect a correcting effect, and the position adjusted in dependence on the detected effect. Particular optical monitors may evaluate the relative locations of reflected light from a mold surface and reflected light from a glazing surface opposite the resin. The relationship between the reflections may be defined to correlate to a desired correcting structure. For example, where it is preferable for the correcting structure to have a surface parallel to an opposite glazing surface, such as surface Si where the correcting structure is molded onto surface S4 in a laminated glazing, light reflected off these may have parallel reflections. The relationship between reflections from the mold surface and an opposing glazing surface may be defined based on the desired correcting structure surface position. Further embodiments may use a monitor for observing the light path through a resin under the mold. Where the mold is transparent, the user may monitor the light travelling through the mold.

In a case the mold is not transparent, the user may monitor the light passing through the glazing or the light reflected on the surface of the mold. If the monitor indicates large distortion of the light, the position of the mold may be further adjusted to optimize the optical properties, including distortion, beam deviation, and/or double imaging.

The applied resin may be cured by heating or radiating ultraviolet light to the resin (at step ST14). Radiation may be administered through the mold if the mold is transparent to the ultraviolet light or through the glazing or part of the glazing if the mold is not transparent to the ultraviolet light where the resin is ultraviolet light cured. The ultraviolet light curing process may not require heat on the surface of the glazing, and therefore, the glazing may not be exposed to unwanted heating which may otherwise affect the glazing shape. Alternatively, the resin may be cured by heat. In a case that the resin is cured by heat, the resin may be hardened even where a very small amount of light reaches the correcting structure.

After the resin is cured, the mold may be released from the surface of the cured resin, which is now molded as the correcting structure (at step ST15). A protection film may be faulted to cover the correcting structure. The protection film may protect the correcting structure during transportation and installation of the glazing. The protective film may be removed prior to use of a light receiving device to receive light through the correcting structure. In some embodiments, an anti-fog film may be provided over the resin to provide an anti-fog surface in the face of a light receiving device.

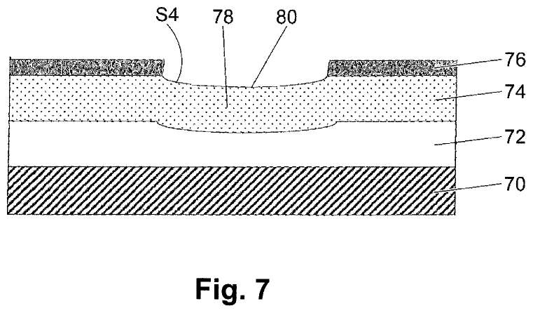

Referring to FIG. 7 to FIG. 12, a process for manufacturing a laminated glazing according to some embodiments is illustrated. This process includes substantially the same steps as the method shown in FIG. 6. First, as shown in FIG. 7, a first glass substrate 70 and a second glass substrate 74 may be prepared with an interlayer 72 as a lamination film located between the first glass substrate 70 and the second glass substrate 74. A screen printing may form an opaque area 76 for creating black ceramic area. Where the opaque area 76 is around a periphery of the glazing, the opaque area 76 may, in some embodiments, at least partially include a dot pattern. After a bending process of this prepared glazing, surface S4 of the second glass substrate 74 may have a recess 80 due to a deformation 78 in the second glass substrate 74 caused from uneven heating and/or other causes.

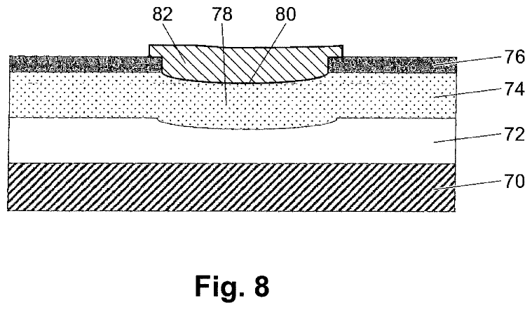

Subsequently, as shown in FIG. 8, a resin 82 may be applied and fills the recess 80. A roll coater or spin coater may be used for filling the recess 80, and if the recess is very small, a droplet or droplets of the resin material may be enough to fill the recess 80. In this embodiment, the resin may be an ultraviolet curable resin such as, e.g., Norland Optical Adhesive 61 (product name) made from Norland Products Incorporated. The resin 82 has a suitable refractive index, such as, e.g., 1.56, which may be substantially the same as the refractive index of the glass substrate 74, so that the resin 82 may prevent unnecessary reflection at the boundary of surface S4,

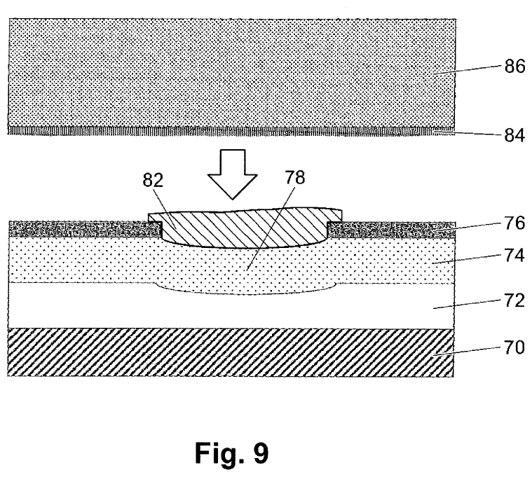

As shown in FIG. 9, a mold 86 may be placed on the applied resin 82. Before the mold 86 is placed on the resin 82, a mold releasing agent 84 may be coated by a spraying method or the like on the surface of the mold 86. The mold releasing agent 84 can be chosen preferably from wax based agents. The spray coating may be performed with, e.g., a solution of 0.2% of the agent in isopropyl alcohol (IPA). The mold releasing agent 84 may be permanent on the mold 86 or may be reapplied before each use of the mold 86.

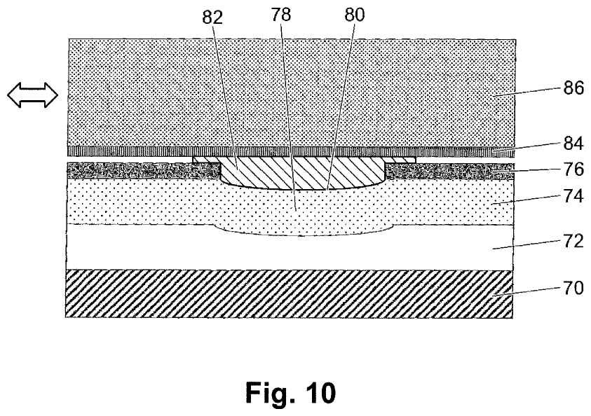

The mold 86 may then be pressed onto the surface S4 of the second glass substrate 74 such that the resin 82 flows to overlap with the opaque area 76 as shown in FIG. 10. When the mold 86 is placed on the resin 82, the exact position of the mold 86 relative to the glazing may be monitored by measuring or detecting light rays through the glazing. If the mold 86 is transparent, the user may monitor the light travelling through the mold 86. If the mold 86 is not transparent, the user may monitor the light passing through the glazing or the light reflected on the surface of the mold 86. If the monitored light shows a double image due to unwanted refractive effects, the position of the mold 86 may not be appropriate as the correcting structure, so that the user can change the position of the mold 86 as to make the resin 82 thicker or thinner to reduce the double image on the monitor. If the monitor shows an optimized image, a desirable correcting structure may be formed by this molding process. The mold 86 in this embodiment may have an optically flat surface made by such as, e.g., No. 47574000 optical flat product from Edmund Optics.

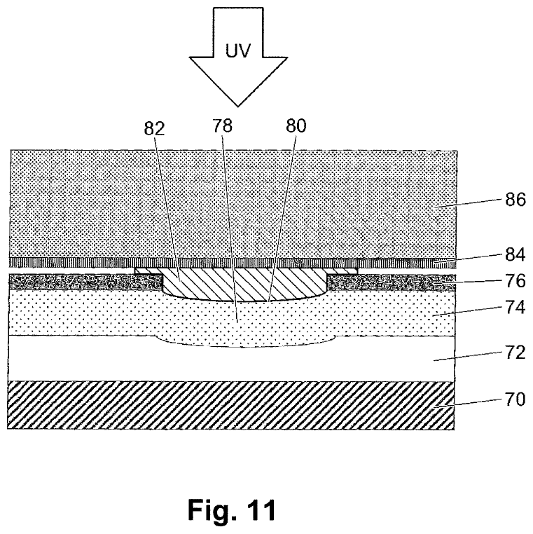

After the mold 86 is positioned on the resin 82, the resin 82 may be treated with ultraviolet light radiation through the mold 86 as shown in FIG. 11. Because of the transparency of the mold 86, the resin 82 is cured adequately in the recess 80. To cure the resin 82, e.g., an LED illumination device may be employed for several to ten seconds. In a case that the resin 82 is fully curable under 3 Joules/cm², an UV-LED device operable with 1250 mW may be sufficient to fully cure the resin 82 in a couple or several seconds.

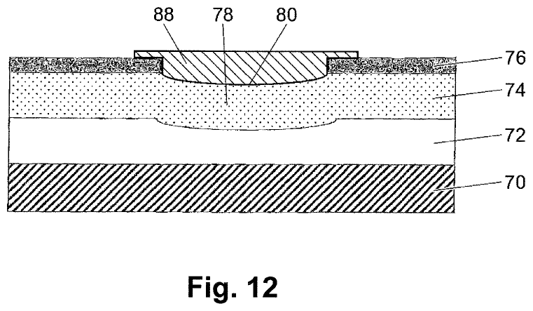

As shown in FIG. 12, the mold 86 may be removed from the surface of the resin 82. At that time, the mold releasing agent 84 may assist with removal of the mold 86. The cured resin 82 filling the recess 80 and having a suitable outer surface form can function as the correcting structure, which effectively improves at least one optical property of light transmitting through the first and second glass substrates and the interlayer.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

In respect of numerical ranges disclosed in the present description it will of course be understood that in the normal way the technical criterion for the upper limit is different from the technical criterion for the lower limit, i.e. the upper and lower limits are intrinsically distinct proposals.

For the avoidance of doubt it is confirmed that in the general description above, in the usual way the proposal of general preferences and options in respect of different features of the automotive glazing and method constitutes the proposal of general combinations of those general preferences and options for the different features, insofar as they are combinable and compatible and are put forward in the same context.

1. A laminated automotive glazing, comprising:
a first glass substrate to face a vehicle exterior, having a first side and a second side;
a second glass substrate to face a vehicle interior, having a third side and a fourth side, the fourth side facing the vehicle interior;
an interlayer laminated between the first and second glass substrates; and
a correcting structure molded on at least a portion of the fourth side of the second glass substrate, for improving an optical property for light transmitting through the first and second glass substrates and the interlayer,
wherein the glazing without the correcting structure has optical distortion, and the correcting structure reduces optical power of the glazing, presented as an absolute value.

2. The glazing according to claim 1, wherein the correcting structure is formed in a portion of the glazing such that a light receiving device is placed adjacent to the correcting structure.

3. The glazing according to claim 1, wherein the optical power of the glazing at the correcting structure, as an absolute value, is 150 mdpt or less.

4-7. (canceled)

8. The glazing according to claim 1, wherein the correcting structure reduces a double image formed by light transmitted through the glazing and the correcting structure.

9. The glazing according to claim 1, further comprising an opaque area around the correcting structure.

10. The glazing according to claim 9, wherein the opaque area partially overlaps with the correcting structure.

11. The glazing according to claim 1, wherein the correcting structure is formed to match light paths from the first side of the first glass substrate.

12. (canceled)

13. (canceled)

14. The glazing according to claim 1, further comprising a coating film over the correcting structure.

15. The glazing according to claim 14, wherein the coating film is a protective coating or an anti-fog film.

16. (canceled)

17. The glazing according to claim 1, wherein the correcting structure has a refractive index within plus or minus 0.05 difference from a refractive index of the second glass substrate, at the visible light wavelength 587.6 nm.

18. The glazing according to claim 1, wherein the correcting structure has a higher refractive index than that of the second glass substrate.

19. A method of producing an automotive glazing having a correcting structure for improving optical properties of light transmitting through the automotive glazing, the method comprising:
preparing at least a glass substrate for the automotive glazing;
applying an uncured resin to the prepared glass substrate;
molding the uncured resin to form a desired correcting structure surface; and
curing the uncured resin to form the correcting structure,
wherein the glazing without the correcting structure has optical distortion, and the correcting structure reduces optical power of the glazing, presented as an absolute value.

20. The method according to claim 19, wherein the uncured resin is molded using a mold, and wherein the mold is positioned in relation to the glass substrate by monitoring light reflecting from or passing through the glass substrate.

21. The method according to claim 19, wherein the resin is ultraviolet (UV)-curable.

22. The method according to claim 21, wherein the resin is UV-cured by administering UV illumination through at least one of the glazing and the mold.

23. The method according to claim 22, wherein the resin is UV-cured by administering UV illumination using the glazing as a waveguide.

24. (canceled)

25. The method according to claim 19, wherein a surface of the glass substrate is subject to a treatment improving adhesion of the correcting structure before the step for molding,

26. An automotive glazing, comprising:
a glass substrate having a first side and a second side, the second side facing a vehicle interior; and
a correcting structure molded on at least a portion of the second side of the glass substrate for improving optical properties of light transmitted through the glass substrate,
wherein the glazing without the correcting structure has optical distortion, and the correcting structure reduces optical power of the glazing, presented as an absolute value.

27. The glazing according to claim 1, wherein the correcting structure has a surface parallel to a surface of the first side of the first glass substrate.
